(19) United States
(12) Patent Application Publication
(10) Pub. No.: US 2014/0176393 A1
(43) Pub. Date: Jun. 26, 2014

(54) INFORMATION PROCESSING APPARATUS, USER ASSISTANCE METHOD AND STORAGE MEDIUM

(71) Applicant: KABUSHIKI KAISHA TOSHIBA, Tokyo (JP)

(72) Inventors: Natsumi Endo, Sagamihara-shi (JP); Koji Hachiya, Akishima-shi (JP)

(73) Assignee: KABUSHIKI KAISHA TOSHIBA, Tokyo (JP)

(21) Appl. No.: 14/066,375

(22) Filed: Oct. 29, 2013

Related U.S. Application Data
(63) Continuation of application No. PCT/JP2013/058118, filed on Mar. 21, 2013.

(30) Foreign Application Priority Data
Dec. 25, 2012 (JP) 2012-281492

(51) Int. Cl. G06F 3/14

(52) U.S. Cl. CPC G06F 3/1423
USPC 345/1.1

(57) ABSTRACT

According to one embodiment, an information processing apparatus includes a recommendation module and a controller. The recommendation module recommends a display mode using at least one of a display and an external display, based on a first information associated with the apparatus, a second information associated with the external display and a rule managed for deriving a display mode. The controller sets the apparatus in the recommended display mode, when an image is displayed in the recommended display mode. The controller sets the apparatus in a display mode other than the recommended display mode and corrects the managed rule, when an image is displayed in a display mode other than the recommended display mode.

### CROSS-REFERENCE TO RELATED APPLICATIONS

This application is a Continuation Application of PCT Application No. PCT/JP2013/058118, filed Mar. 21, 2013 and based upon and claiming the benefit of priority from Japanese Patent Application No. 2012-281492, filed Dec. 25, 2012, the entire contents of all of which are incorporated herein by reference.

### FIELD

Embodiments described herein relate generally to a user assistance technique suitable for a notebook personal computer connectable to an external display device, for example.

### BACKGROUND

A battery-driven notebook personal computer (PC) has recently come into widespread use. This type of PC includes a connector to which an external device is connectable. A user is able to extend the function of the PC widely and appropriately by connecting various external devices to the connector when the need arises.

For the above reason various methods such as a method for automatically making setting about the external device connected to the connector have been proposed.

A notebook PC incorporates a display device such as an LCD, and an external display device can be connected to the PC as an external device. There is not only a case where the external display device is used in place of the display device incorporated into the PC but also a case where the external display device is used along with the display device incorporated into the PC. In the latter case, two display modes can be employed. One of the display modes is a clone display mode for performing a presentation, a demonstration, and the like (for displaying the same image on two display devices) and the other display mode is a multi-monitor display mode for expanding a work space (display area) (for displaying different images on two display devices). In order to perform a presentation, not the clone display mode but the multi-monitor display mode can be selected.

Actually, general users are unfamiliar with an operation of setting a PC though they have mastered operations about various application programs that are executed on a PC. In the meanwhile, as the number of external display devices connected to the PC increases to two and three, there is an increasing tendency to complicate an operating procedure for selecting a display mode.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an outward appearance of an information processing apparatus according to an embodiment.

FIG. 2 is an exemplary block diagram showing a system configuration of the information processing apparatus according to the embodiment.

FIG. 3 is an exemplary illustration for explaining a display mode that can be selected in the information processing apparatus according to the embodiment when an external display device is connected.

FIG. 4 is an exemplary illustration for explaining the present problem caused when an external display device is connected.

FIG. 5 is an exemplary illustration for explaining a general outline of user assistance by a display setting utility program executed on the information processing apparatus according to the embodiment.

FIG. 6 is an exemplary functional block diagram for explaining the operating principle of the display setting utility program executed on the information processing apparatus according to the embodiment.

FIG. 7 is an exemplary first illustration for explaining a user interface provided by the display setting utility program executed on the information processing apparatus according to the embodiment.

FIG. 8 is an exemplary second illustration for explaining a user interface provided by the display setting utility program executed on the information processing apparatus according to the embodiment.

FIG. 9 is an exemplary third illustration for explaining a user interface provided by the display setting utility program executed on the information processing apparatus according to the embodiment.

FIG. 10 is an exemplary display mode transition diagram of the information processing apparatus according to the embodiment.

FIG. 11 is an exemplary view showing an example of a score table prepared for the information processing apparatus according to the embodiment.

FIG. 12 is an exemplary graph showing an example of an evaluation function used by the display setting utility program executed on the information processing apparatus according to the embodiment.

FIG. 13 is an exemplary table showing an example of a status list prepared by the display setting utility program executed on the information processing apparatus according to the embodiment.

FIG. 14 is an exemplary graph showing an example of an approximation curve computed by the display setting utility program executed on the information processing apparatus according to the embodiment.

FIG. 15 is an exemplary graph showing an example of correction of the evaluation function by the display setting utility program executed on the information processing apparatus according to the embodiment.

FIG. 16 is an exemplary flowchart showing a processing procedure of the display setting utility program executed on the information processing apparatus according to the embodiment.

### DETAILED DESCRIPTION

Various embodiments will be described hereinafter with reference to the accompanying drawings.

In general, according to one embodiment, an information processing apparatus includes a display, a connector to which an external display is connected, an acquisition module, a manager, a recommendation module and a controller. The acquisition module is configured to acquire first information associated with the apparatus and second information associated with the external display connected to the connector. The manager is configured to manage a rule for deriving a display mode using at least one of the display and the external display connected to the connector. The recommendation module is configured to recommend a display mode using at least one of the display and the external display connected to the connector, based on the first information and the second information acquired by the acquisition module and the rule managed by the manager. The controller is configured to set the apparatus in the display mode recommended by the recommendation module, when an image is displayed in the display mode recommended by the recommendation module. The controller is further configured to set the apparatus in a display mode other than the display mode recommended by the recommendation module and to correct the rule managed by the manager, when an image is displayed in a display mode other than the display mode recommended by the recommendation module.

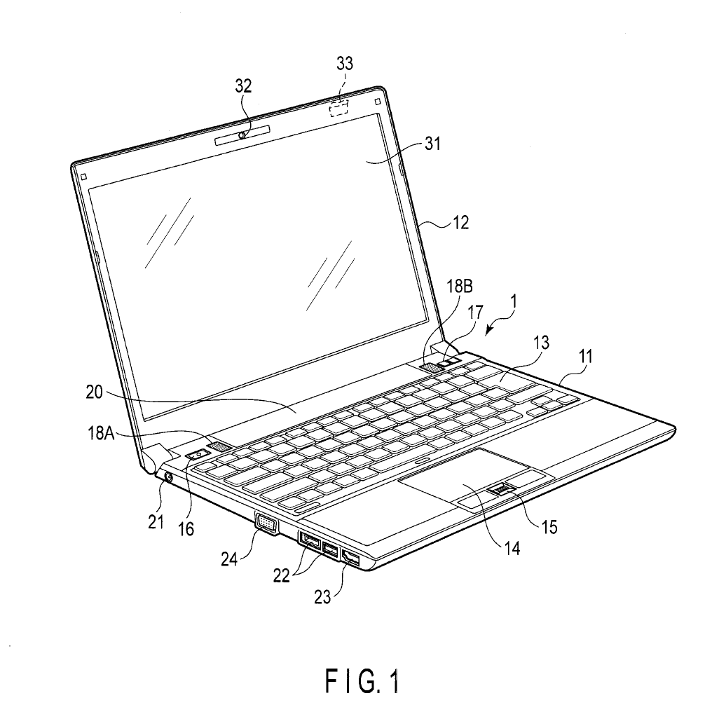

Referring first to FIG. 1, the configuration of an information processing apparatus according to the embodiment will be described. As shown in FIG. 1, the information processing apparatus can be achieved as a notebook personal computer 1, for example.

FIG. 1 is an exemplary perspective view of the computer 1 whose display unit is opened. The computer 1 is configured to receive power from a battery 20. The computer 1 includes a computer main body 11 and a display unit 12. The display unit 12 incorporates a display device such as an LCD 31. Furthermore, the display unit 12 includes a camera (Web camera) 32 and an illuminance sensor 33 on its upper end portion.

The display unit 12 is attached to the computer main body 11 such that it can be turned between an open position in which the top surface of the computer main body 11 is exposed and a closed position in which the top surface of the computer main body 11 is covered. The computer main body 11 includes a thin box-shaped housing and its top surface is provided with a keyboard 13, a touch pad 14, a fingerprint sensor 15, a power switch 16 for turning on/off the computer 1, some functional buttons 17, and speakers 18A and 18B.

The computer main body 11 also includes a power supply connector 21. The power supply connector 21 is provided on one side of the computer main body 11, for example, the left side thereof. To the power supply connector 21, an external power supply device is detachably connected. As the external power supply device, an AC adapter can be used. The AC adapter is a power supply device for converting commercial power (AC power) into DC power.

The battery 20 is detachably mounted on, for example, the rear end portion of the computer main body 11. The battery 20 can be replaced with a battery built in the computer 1.

The computer 1 is driven by power from the external power supply device or power from the battery 20. If the external power supply device is connected to the power supply connector 21 of the computer 1, the computer 1 is driven by power from the external power supply device. The power from the external power supply device is also used for charging the battery 20. During a time period in which the external power supply device is not connected to the power supply connector 21 of the computer 1, the computer 1 is driven by power from the battery 20.

The computer main body 11 also includes some USB ports 22, a high-definition multimedia interface (HDMI) output terminal 23, a VGA (RGB) port 24 and a LAN connector 25 (not shown in FIG. 1).

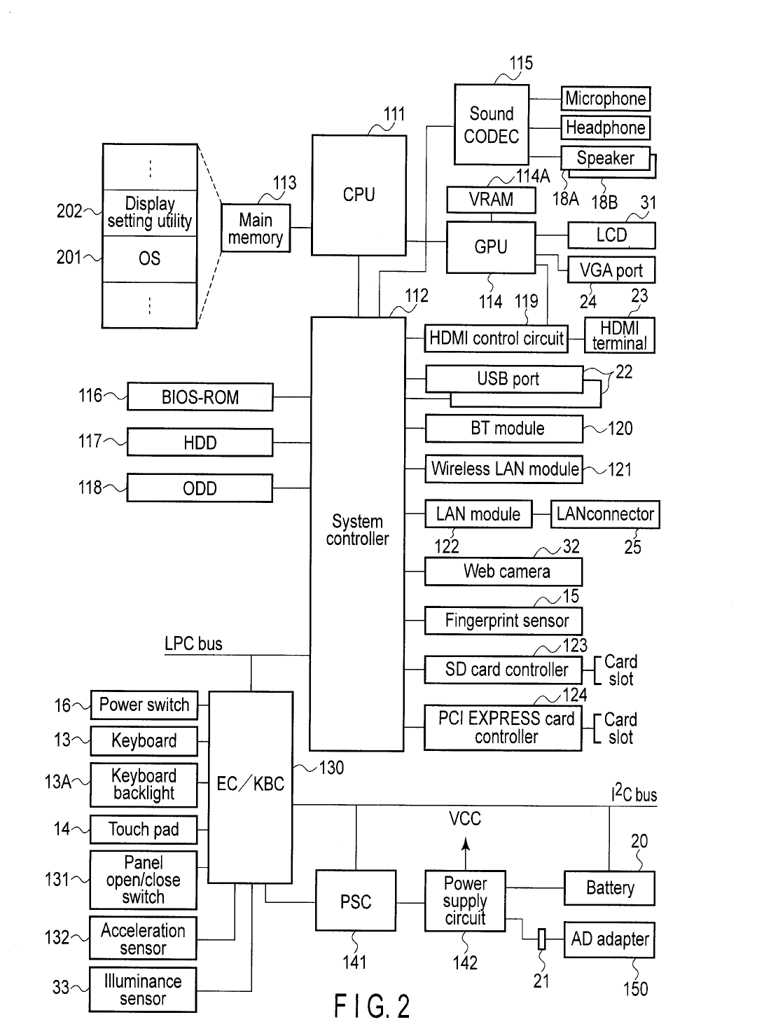

FIG. 2 shows a system configuration of the computer 1. The computer 1 includes a CPU 111, a system controller 112, a main memory 113, a graphics processing unit (GPU) 114, a sound codec 115, a BIOS-ROM 116, a hard disk drive (HDD) 117, an optical disk drive (ODD) 118, a BT (Bluetooth: registered trademark) module 120, a wireless LAN module 121, a LAN module 122, an SD card controller 123, a PCI EXPRESS card controller 124, an embedded controller/keyboard controller IC (EC/KBC) 130, a keyboard backlight 13A, a panel open/close switch 131, an acceleration sensor 132, a power supply controller (PSC) 141, a power supply circuit 142 and the like.

The CPU 111 is a processor for controlling the operation of each of the components of the computer 1. The CPU 111 executes various pieces of software loaded into the main memory 113 from the HDD 117. The software includes an operating system (OS) 201 and various application programs. The software also includes a display setting utility program 202, which will be described later.

The CPU 111 also executes a basic input/output system (BIOS) stored in the BIOS-ROM 116 that is a nonvolatile memory. The BIOS is a system program for controlling hardware.

The GPU 114 is a display controller for controlling the LCD 31 incorporated into the display unit 12. The GPU 114 generates a display signal (LVDS signal) from display data stored in the video memory (VRAM) 114A, and the display signal is to be supplied to the LCD 31. The GPU 114 is able to generate an analog RGB signal and an HDMI video signal from the display data, too. The analog RGB signal is supplied to the external display device via the VGA port 24. The HDMI output terminal 23 is able to send an HDMI video signal (uncompressed digital video signal) and a digital audio signal to the external display device through a single cable. The HDMI control circuit 119 is an interface for sending the HDMI video signal and digital audio signal to the external display device via the HDMI output terminal 23.

The system controller 112 is a bridge device for connecting the CPU 111 and each of the components. The system controller 112 incorporates a serial ATA controller for controlling the hard disk drive (HDD) 117 and optical disk drive (ODD) 118. Furthermore, the system controller 112 carries out communications with each of the devices on an LPC (low pin count) bus.

The EC/KBC 130 is connected to the LPC bus. The EC/KBC 130, power supply controller (PSC) 141 and battery 20 are connected to each other via a serial bus such as an I2C bus.

The EC/KBC 130 is a power management controller for managing power of the computer 1. For example, the EC/KBC 130 is achieved as a one-chip microcomputer including a keyboard controller for controlling the keyboard (KB) 13, touch pad 14 and the like. The EC/KBC 130 includes a function of powering on/off the computer 1 in accordance with a user operation of the power switch 16. The control for power-on and power-off of the computer 1 is performed by the cooperation between the EC/KBC 130 and the power supply controller (PSC) 141. Upon receiving an ON signal from the EC/KBC 130, the power supply controller (PSC) 141 controls the power supply circuit 142 to power on the computer 1. Upon receiving an OFF signal from the EC/KBC 130, the power supply controller (PSC) 141 controls the power supply circuit 142 to power off the computer 1. The EC/KBC 130, power supply controller (PSC) 141 and power supply circuit 142 are operated by power from the battery 20 or AC adapter 150 even during a time period in which the computer 1 is powered off.

The EC/KBC 130 is able to turn on/off the keyboard backlight 13A provided on the back of the keyboard 13. Furthermore, the EC/KBC 130 is connected to the panel open/close switch 131 configured to detect the opening and closing of the display unit 12. If the panel open/close switch 131 detects the opening of the display unit 12, the EC/KBC 130 is able to power on the computer 1. Moreover, the EC/KBC 130 is supplied with a detection signal of the acceleration sensor 132 and a detection signal of the illuminance sensor 33. The detection signal of the acceleration sensor 132 is used for, for example, controlling the protection of the HDD 117, and the detection signal of the illuminance sensor 33 is used for, for example, controlling the luminance of the LCD 31.

The power supply circuit 142 generates power (operating power), which is to be applied to each of the components, using power from the battery 20 or power from the AC adapter 150 connected to the computer main body 11 as an external power supply.

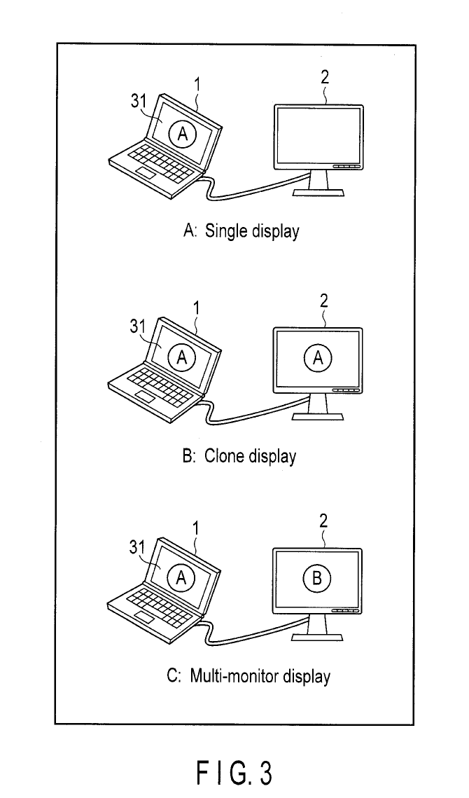

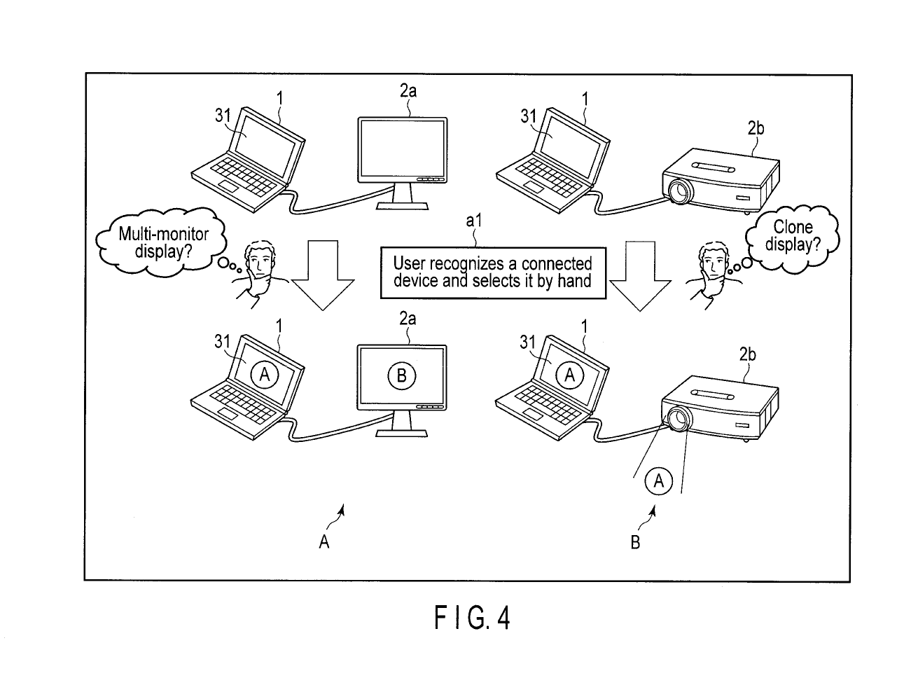

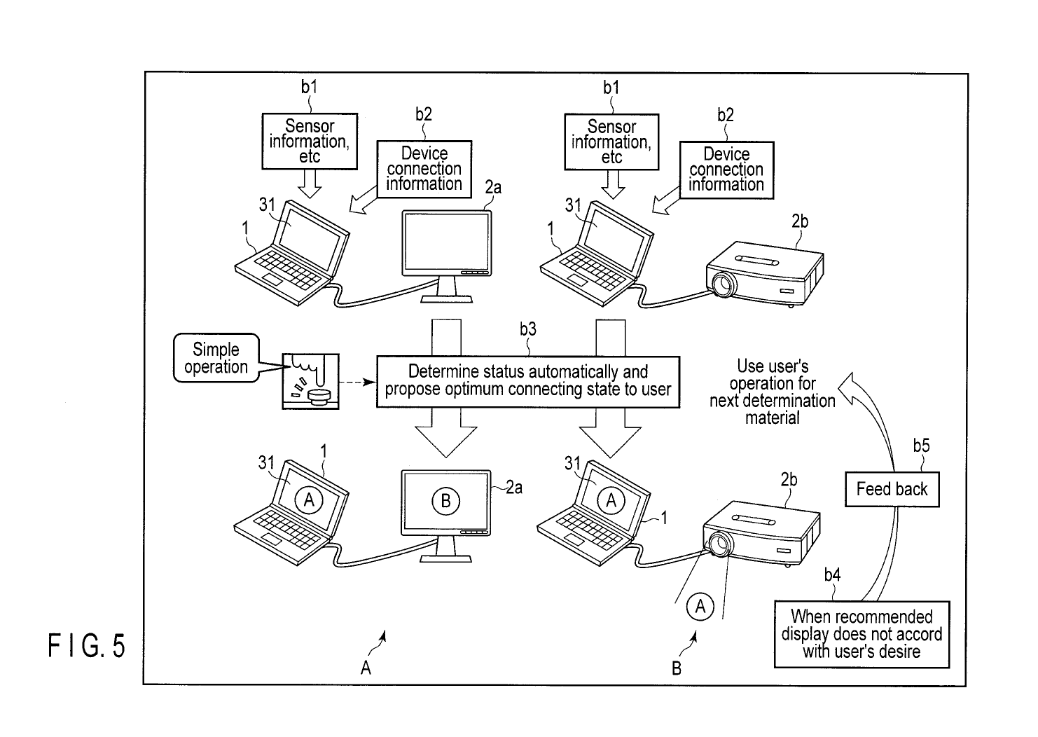

Referring next to FIG. 3, FIG. 4 and FIG. 5, the function of the display setting utility program 202 executed on the computer 1 with the above configuration will be described.

As described above, the computer main body 11 of the computer 1 is provided with the HDMI output terminal 23 and VGA port 24. Accordingly, an external display device 2 as well as the display device (LCD 31) incorporated into the display unit 12 can be connected to the computer 1 when the need arises. FIG. 3 is an exemplary illustration for explaining a display mode that can be selected in the computer 1 when the external display device 2 is connected to the computer 1. Here, the HDMI output terminal 23 and the VGA port 24 are referred to as terminals capable of connecting the external display device 2; however, the terminals are not limited to them but can be replaced with DisplayPort or the like.

As shown in FIG. 3, when the external display device 2 is connected to the computer 1, three display modes of a single display mode “A”, a clone display mode “B” and a multi-monitor display mode “C” can be designated.

The single display mode is a display mode in which an image is displayed on only one of the LCD 31 of the computer 1 and the external display device 2. “A” of FIG. 3 shows the single display mode in which an image is displayed on only the LCD 31 of the computer 1. The clone display mode is a display mode in which the same image is displayed on both the LCD 31 of the computer 1 and the external display device 2. The multi-monitor display mode is a display mode in which different images are displayed on the LCD 31 of the computer 1 and the external display device 2, respectively.

For your understanding of the function of the display setting utility program 202 executed on the computer 1, the present problem caused when the external display device 2 is connected to the computer 1 will be described with reference to FIG. 4.

Assume that a user connects a display device 2a to the computer 1 and wishes to display different images on the LCD 31 of the computer 1 and the display device 2a (“A” of FIG. 4). Also, assume that another user connects a projector 2b to the computer 1 and wishes to display an image, which is displayed on the LCD 31 of the computer 1, on the projector 2b (“B” of FIG. 4). Though the display device 2a and projector 2b both correspond to the external display device 2, they are denoted by different numbers 2a and 2b here for the sake of convenience.

Even in either of the above cases, at the present time, the user needs to think a desired display mode by himself or herself and selects it on the setting screen (a1 in FIG. 4).

At this time, the user considers it or if the user is a beginner, it is difficult for the beginner to select a display mode. In these latter days, as the number of display devices connected to a computer increases to two or three, the selection becomes complicated. More specifically, the following matters should be considered.
A user wishes to set a computer in his or her own desired display mode when an external display device is connected to the computer.
A user's desired display mode depends upon his or her purpose and liking.
To set a computer in a desired display mode, a user needs to consider the display mode by himself or herself and select it.
As the number of external display devices increases, the selecting operation becomes complicated.

As shown in FIG. 5, the display setting utility program 202 provides a user with a mechanism to release the user from a complicated setting operation by analyzing the current status from various items of information (b1 and b2 of FIG. 5) of the computer 1 and the external display device 2 and guessing and proposing a user's desired display mode (b3 in FIG. 5). The display setting utility program 202 also provides the user with a mechanism to learn a user's liking based on a user's decision (b4 and b5 in FIG. 5) and recommend a display mode suitable for the user at the time of the next setting. The details for this will be described below.

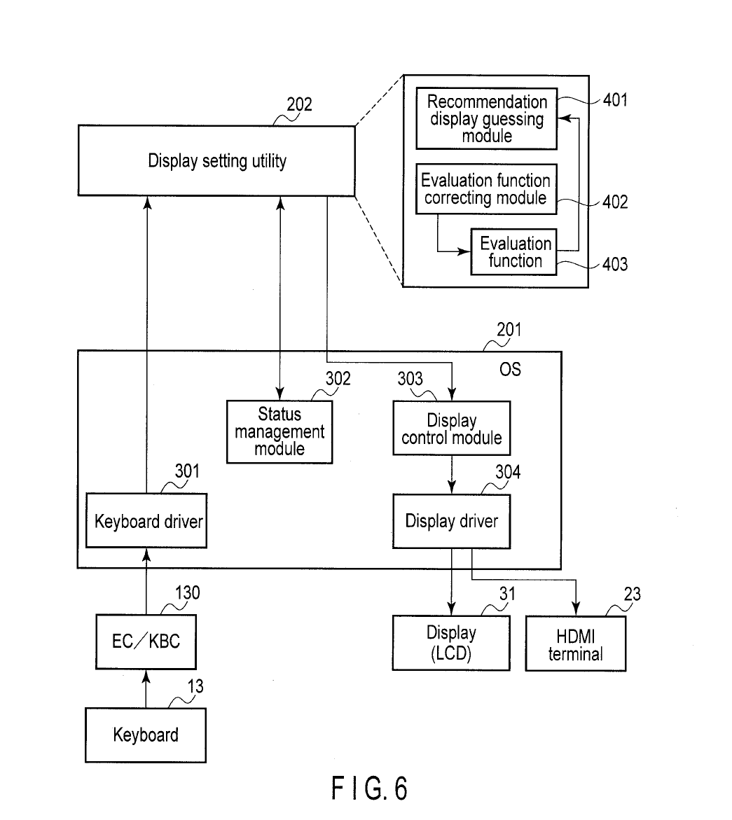

FIG. 6 is an exemplary functional block diagram for explaining the operating principle of the display setting utility program 202.

As shown in FIG. 6, the display setting utility program 202 includes a recommendation display guessing module 401 and an evaluation function correcting module 402. Also, the display setting utility program 202 is provided with an evaluation function (rule) 403.

The recommendation display guessing module 401 is a module to guess, using the evaluation function 403, a display mode to be recommended from various items of information from the computer 1 and the external display device 2. The evaluation function correcting module 402 is a module to correct the evaluation function 403 when it can be determined that a result guessed by the recommendation display guessing module 401 is incorrect (to a user).

If a preset function key (e.g., Fn key+F5 key) on the keyboard 13 is depressed, the EC/KBC 130 generates a key code of the function key and stores it in a built-in register, and then issues an interrupt signal to the CPU 111. If the interrupt signal is issued, a keyboard driver 301 of the OS 201 (executed by the CPU 111) reads the key code out of the built-in register of the EC/KBC 130. When the key code input by the keyboard driver 301 is a key code corresponding to the above preset function key, the OS 201 notifies the display setting utility program 202 that the preset function key is depressed.

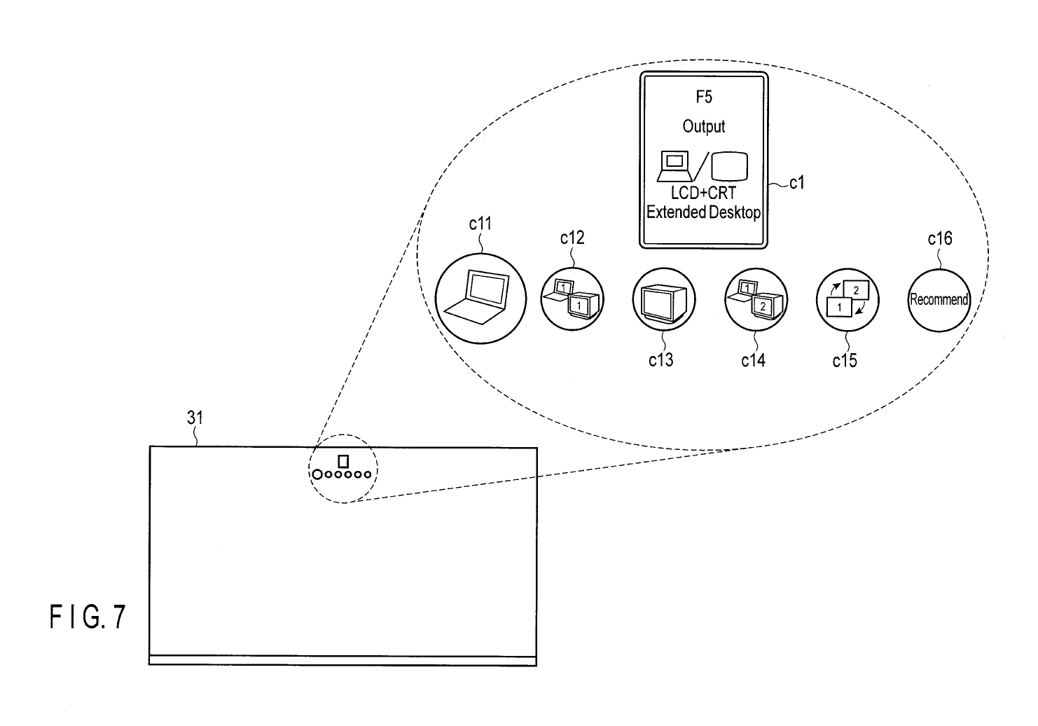

The display setting utility program 202 that has received this notification inquires of a status management module 302 of the OS 201 whether the external display device 2 is connected. If the external display device 2 is connected, the display setting utility program 202 requests a display control module 303 of the OS 201 to display an object group (c1, c11, c12, c13, c14, c15 and c16) shown in FIG. 7, for example. The display control module 303 that has received the request from the display setting utility program 202 displays the object group (c1, c11, c12, c13, c14, c15 and c16) on the LCD 31 through a display driver 304.

In FIG. 7, object c1 is an image which makes a user confirm that the depressed function key is a function key for setting a display mode and an image which makes the user confirm display environment. In the environment shown in FIG. 7, an image can be displayed on either or both of the LCD 31 of the computer 1 and the external display device 2.

Object c11 is an icon for selecting a single display mode on the LCD 31 of the computer 1. Object c11 is displayed in size larger than other objects c12, c13, c14, c15 and c16 for the reason that its icon is selected. It is assumed here that the user has just connected the external display device 2 to the computer 1 and depressed a function key (Fn key+F5 key) while an image is displayed on only the LCD 31 of the computer 1. When the display setting utility program 202 acquires information as to whether the external display device 2 is connected from the status management module 302 of the OS 201, it also acquires information about a display mode at that time. On the basis of this information, the display setting utility program 202 displays object c11 in size larger than objects c12, c13, c14, c15 and c16 (because the size is displayed on only the LCD 31 of the computer 1).

Object c12 is an icon for selecting a clone display mode on the LCD 31 of the computer 1 and the external display device 2. If the user depresses the F5 key again while maintaining depression of the Fn key, the next icon can be set in a selected state. In other words, if the operation (the F5 key is depressed again while depression of the Fn key is maintained) is performed in the state shown in FIG. 7, the icon is displayed in size larger than the other icons. Each time the operation is performed, an icon displayed in larger size is changed to its right-sided icon. If the operation is performed while the rightmost icon (object c16) is displayed in larger size, the state returns to that shown in FIG. 7.

If the user releases his or her finger from the Fn key, he or she can accept the selection of an icon in a selected state. If the selection of an icon (object c12) is accepted, the display setting utility program 202 requests the display control module 303 of the OS 201 to make a clone display on the LCD 31 of the computer 1 and the external display device 2. The display control module 303 of the OS 201 that has received the request instructs the display driver 304 to output an image, which was output only to the LCD 31, to the HDMI output terminal 23 or VGA port 24, too. Assume here that the external display device 2 is connected to the HDMI output terminal 23 (shown in FIG. 6). At this time, the display setting utility program 202 performs a process for erasing the object group (c1, c11, c12, c13, c14, c15 and c16) displayed on the LCD 31.

Object c13 is an icon for selecting a single display mode on the external display device 2. Object c14 is an icon for selecting a multi-monitor display mode on the LCD 31 of the computer 1 and the external display device 2. Object c15 is an icon for changing an output destination of the master screen in the multi-monitor display mode on the LCD 31 of the computer 1 and the external display device 2. In the multi-monitor display mode, for example, an image for a GUI of the OS 201 and a shortcut are displayed on the master screen. If the function key for setting a display mode is depressed in the multi-monitor display mode, the object group (c1, c11, c12, c13, c14, c15 and c16) displayed by the display setting utility program 202 is also displayed on the master screen.

Object c16 is an icon for selecting the optimum display mode automatically according to the current status. In other words, when the external display device 2 is connected to the computer 1, the user has only to select the icon without due consideration. Hereinafter, the operating principle of the display setting utility program 202 executed when the icon is selected will be described.

If the function key for setting a display mode is depressed while the external display device 2 is not connected to the computer 1, information indicating that the external display device 2 is not connected is returned from the status management module 302 of the OS 201. In this case, the display setting utility program 202 displays an object in place of object c1 shown in FIG. 7, the object being an image which makes the user confirm that the depressed function key is the function key for setting a display mode and an image which can be displayed only on the LCD 31 of the computer 1. At this time, the display setting utility program 202 displays only object c11 of objects c11, c12, c13, c14, c15 and c16 shown in FIG. 7 as a selectable icon.

When object c16 is selected, the recommendation display guessing module 401 of the display setting utility program 202 acquires, for example, the following information from the status management module 302 of the OS 201.
Information about the external display device 2 (number, aspect ratio, resolution, etc.) connected to the computer and connection terminal (HDMI output terminal 23, VGA port 24, DisplayPort, etc.).
Information about connection of the network (wired LAN), Dock equipment, AC adapter 150, etc.
Sensor information of illuminance sensor 33 and the like.
Information about application that is currently executed.

The recommendation display guessing module 401 acquires the above information, it makes the following determinations.
When the computer 1 is not connected to a wired LAN, a display device of relatively low resolution is connected to the VGA port 24, and the illuminance detected by the illuminance sensor 33 is lower than that of indoor lighting, the module 401 determines that a user is going to make a presentation and thus recommends the clone display mode.
When the computer 1 is connected to Dock equipment and one or more display devices are connected to the Dock equipment, the module 401 recommends the multi-monitor display mode to enlarge a work space.
When two or more display devices are connected to the computer 1, the module 401 recommends the multi-monitor display mode to enlarge a work space.

The above determinations are made by comparing a status value computed from device information (of the computer 1 and external display device 2) acquired as described above and the evaluation function 403 for evaluating the status value.

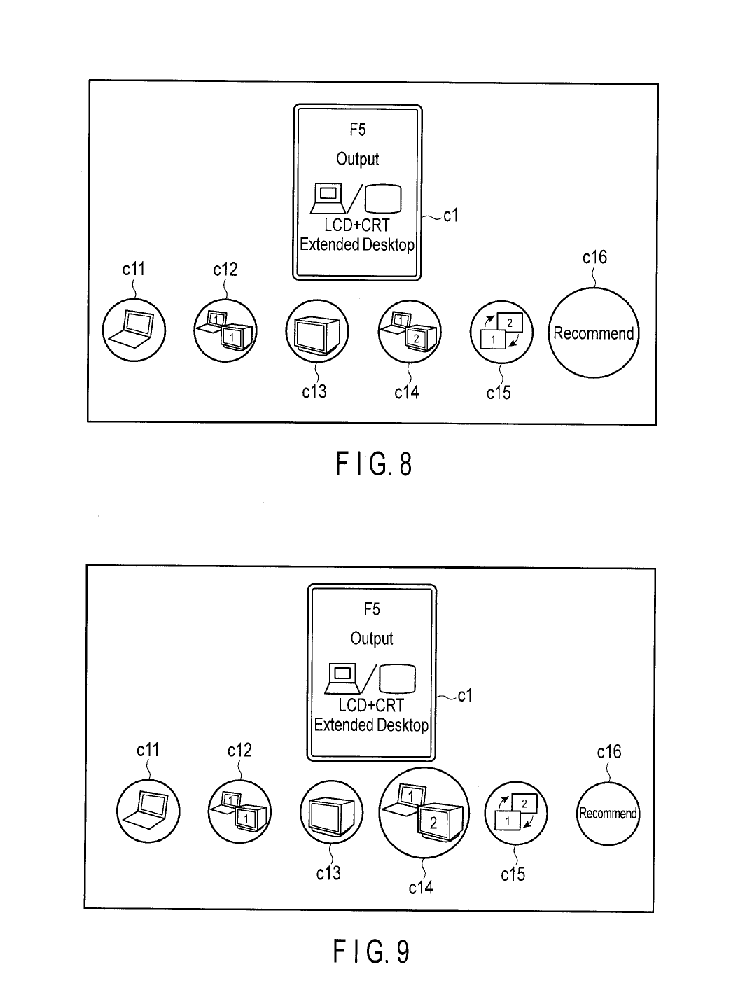

As described above, the recommendation display guessing module 401 guesses the optimum display mode for a user when the external display device 2 is connected to the computer 1. If the user selects one of objects c11, c12, c13, c14 and c15 shown in FIG. 7, the display setting utility program 202 accepts a display mode corresponding to the selected object when the user releases his or her finger from the Fn key, as described above. In contrast, as shown in FIG. 8, if the user selects object c16, when the recommendation display guessing module 401 recommends a display mode (before the user releases his or her finger from the Fn key), the display setting utility program 202 accepts the display mode. The program 202 provides the user with the display mode as “a recommended display mode”.

If the recommended display mode accords with the user's desire, the user can complete the operation for selecting a display mode only by releasing his or her finger from the Fn key. In other words, the user is able to select a display mode through a simple operation of selecting object c16.

Since the display setting utility program 202 proceeds to provide an interface similar to the conventional one, the user is able to select a display mode using the conventional interface if the recommended display mode does not accord with the user's desire. In other words, the display setting utility program 202 can proceed to provide the same as the conventional function.

On the basis of the user's decision (in the case where the display mode recommended by the recommendation display guessing module 401 does not accord with the user's desire), the evaluation function correcting module 402 determines that the user does not like the recommended display mode under the condition, and feeds the information back to the evaluation function 403. Therefore, when a “recommended display mode” is guessed next time, a different display mode is guessed according to a user's liking.

Assume the following case. Object c16 is selected as shown in FIG. 8. The recommendation display guessing module 401 guesses the clone display mode and the display setting utility program 202 recommends the clone display mode to the user. After that, as shown in FIG. 9, object c14, which is an icon for selecting the multi-monitor display mode, is selected again (while depression of the Fn key is maintained). In this case, the evaluation function correcting module 402 determines that the guess of the recommendation display guessing module 401 is incorrect.

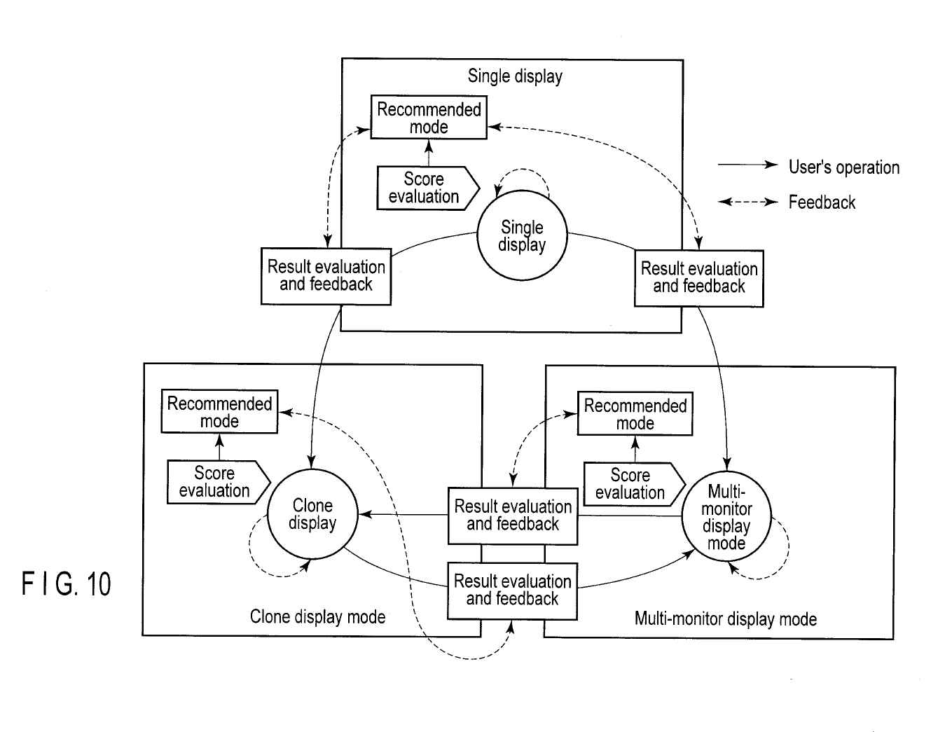

FIG. 10 is an exemplary display mode transition diagram showing how the current display mode transitions in the computer 1.

According to the diagram of FIG. 10, score evaluation is made for each of the single display mode, clone display mode and multi-monitor display mode, a recommended display mode is guessed, and a user's actual operation is fed back to the score evaluation.

Next, an algorithm for recommending the optimum display mode by the display setting utility program 202 will be described.

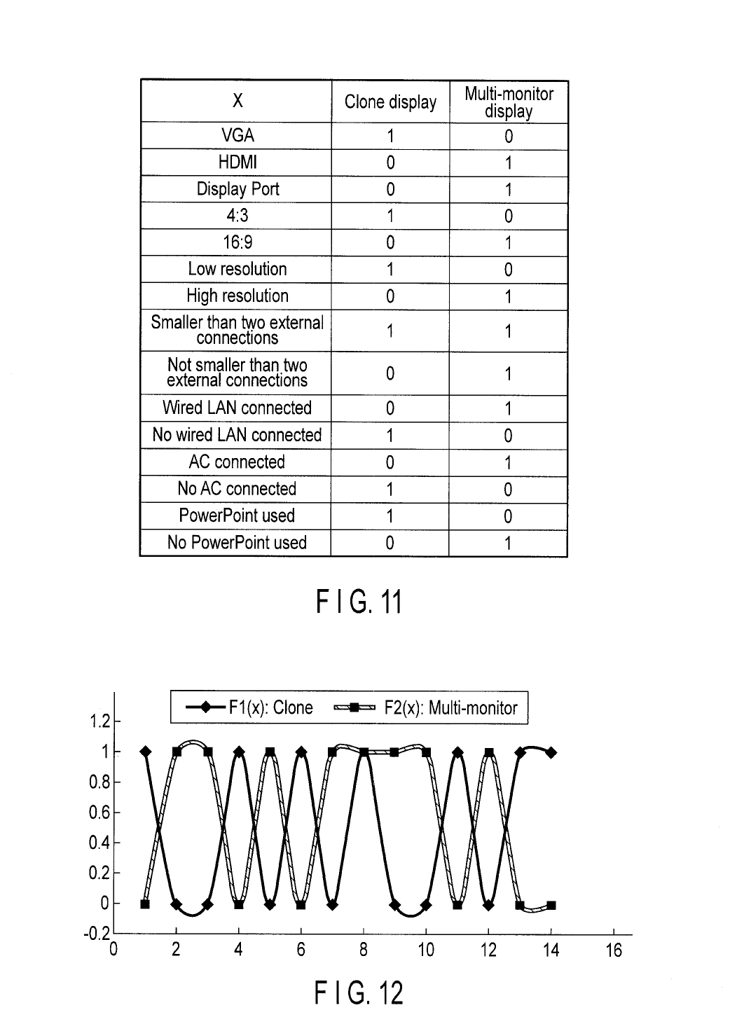

First, a beginning-stage score with which the state of the computer 1 is considered to be in conformity is given to each of the display modes, and a score table as shown in FIG. 11 is prepared. If the computer 1 is in a VGA connecting state, a high score is given to the clone display. If the computer 1 is in an AC connecting state, a high score is given to the multi-monitor display. If the computer 1 is not in an AC connecting state, or it is driven by a battery, a high score is given to the clone display on the grounds that there is a strong possibility that the computer 1 will be brought in a meeting room for making a presentation, for example. From this information, the evaluation function 403 as shown in, e.g., FIG. 12 is derived. Fn(x) is an approximate curve that satisfies all given status values x.

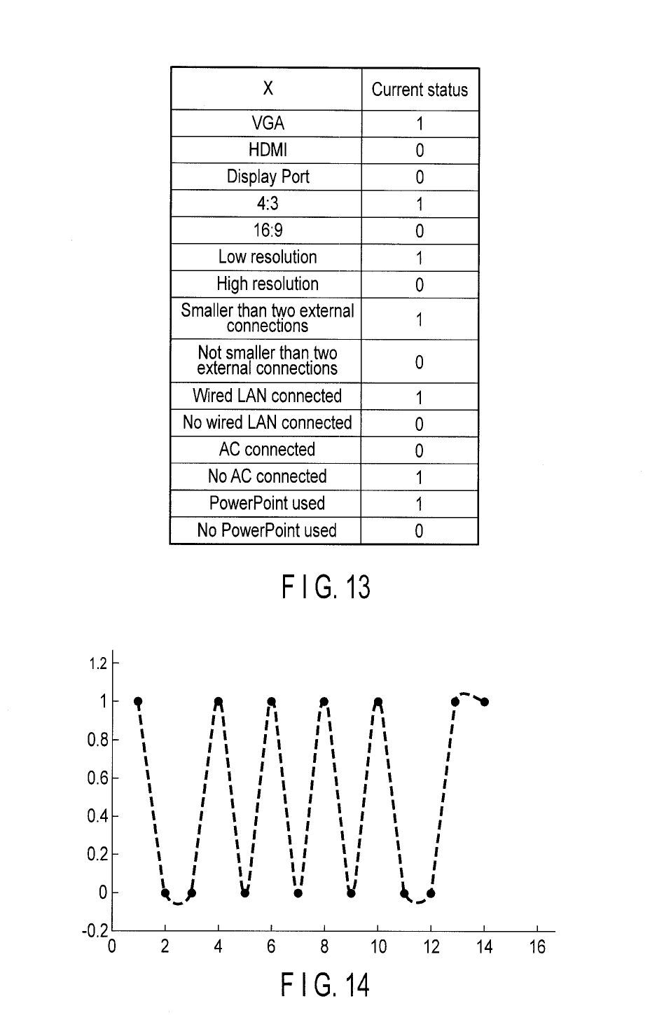

To recommend a display mode, the recommendation display guessing module 401 acquires each status of a device from the status management module 302 of the OS 201, extracts statuses conforming to items in the score table and makes a status list including the statuses. Such a status list is shown in FIG. 13, for example. As the evaluation function 403 is derived from the aforementioned score table, the recommendation display guessing module 401 computes, for example, an approximate curve as shown in FIG. 14 from the status list.

The recommendation display guessing module 401 compares the computed approximate curve and the evaluation function 403. Here, a function having a large number of contact peaks is retrieved. In this example, the “clone display mode” is a recommended display mode.

If the recommended display mode is obtained by the recommendation display guessing module 401, the display setting utility program 202 recommends the user with the display mode, or the clone display mode and waits for user's action. The user selects the recommended display mode or another display mode.

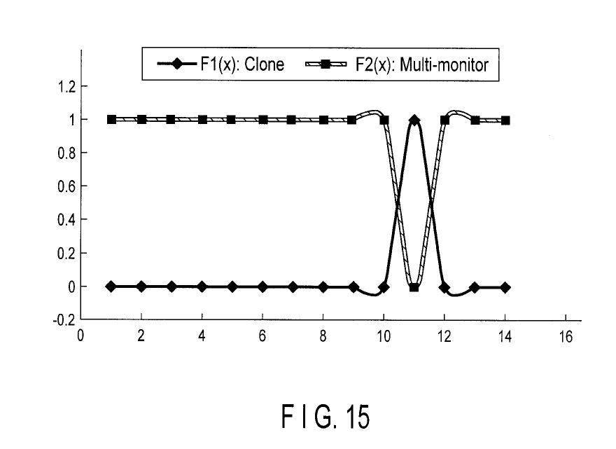

If the user selects not the recommended display mode (“clone display mode”) but the “multi-monitor display mode”, the evaluation function correcting module 402 feeds the information back to the evaluation function. Taking into consideration that the “multi-monitor display mode” is selected in this state, the evaluation function correcting module 402 corrects an error for each of the clone display function and the multi-monitor display function as shown in FIG. 15.

If the recommendation display guessing module 401 guesses a recommended display mode next in the same environment using the corrected evaluation function 403, it guesses the multi-monitor display mode to be a recommended display mode because a function having the largest number of contact peaks corresponds to the multi-monitor display.

As described above, a recommended display mode can be changed adaptively according to user's environment.

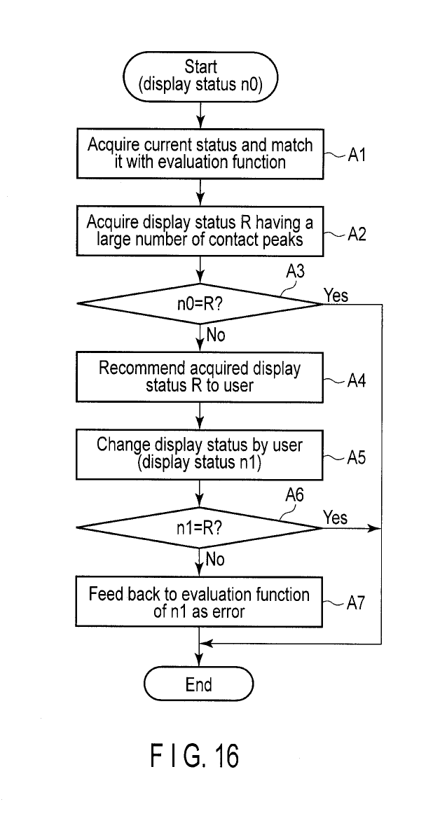

FIG. 16 is an exemplary flowchart showing a processing procedure of the display setting utility program 202.

The recommendation display guessing module 401 acquires the current statuses from the status management module 302 of the OS 201, computes an approximate curve and match it with the evaluation function 403 (block A1). Then, the recommendation display guessing module 401 acquires a display mode corresponding to a function having a large number of contact peaks (block A2).

If the display mode acquired by the recommendation display guessing module 401 matches the current display mode (Yes in block A3), the display setting utility program 202 does not do anything. If the display mode does not match the current display mode (No in block A3), the display setting utility program 202 recommends the user with the display mode acquired by the recommendation display guessing module 401 (block A4).

After recommending the display mode, the display setting utility program 202 changes the display mode according to a user's operation (block A5). The display setting utility program 202 checks whether the display mode selected by the user matches the display mode acquired by the recommendation display guessing module 401 (block A6). If they do not match (No in block A6), the evaluation function correcting module 402 feeds the result back to the evaluation function 403.

As described above, the computer 1 is able to set a display mode, which is guessed to be the optimum from the currents status and the past usage track records, through a simple operation.

In the foregoing description, as a method for deriving a recommended display mode, a simple evaluation function is employed. In addition, it can be derived by learning a user's liking using learning by teacher, enforced learning and the like.

All the operating procedures according to the embodiment can be achieved by software. If, therefore, the software is introduced into a normal computer through a computer readable storage medium, the same advantage as that of the embodiment can easily be brought about.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display;
a connector to which an external display is connected;
an acquisition module configured to acquire first information associated with the apparatus and second information associated with the external display connected to the connector;
a manager configured to manage a rule for deriving a display mode using at least one of the display and the external display connected to the connector;
a recommendation module configured to recommend a display mode using at least one of the display and the external display connected to the connector, based on the first information and the second information acquired by the acquisition module and the rule managed by the manager; and
a controller configured:
to set the apparatus in the display mode recommended by the recommendation module, when an image is displayed in the display mode recommended by the recommendation module; and
to set the apparatus in a display mode other than the display mode recommended by the recommendation module and to correct the rule managed by the manager, when an image is displayed in a display mode other than the display mode recommended by the recommendation module.

2. The apparatus of claim 1, wherein the display mode recommended by the recommendation module and using at least one of the display and the external display connected to the connector comprises a clone display mode in which a same image is displayed on both the display and the external display connected to the connector.

3. The apparatus of claim 1, wherein the display mode recommended by the recommendation module and using at least one of the display and the external display connected to the connector comprises a multi-monitor display mode in which a first image is displayed on the display and a second image different from the first image is displayed on the external display connected to the connector.

4. The apparatus of claim 1, wherein the first information acquired by the acquisition module comprises a type of interface used for outputting an image signal to an external display.

5. The apparatus of claim 1, wherein the second information acquired by the acquisition module comprises an aspect ratio of the external display connected to the connector.

6. The apparatus of claim 1, wherein the second information acquired by the acquisition module comprises resolution of the external display connected to the connector.

7. The apparatus of claim 1, wherein the first information acquired by the acquisition module comprises the number of external displays connected to the apparatus.

8. The apparatus of claim 1, wherein the first information acquired by the acquisition module comprises information as to whether the apparatus is connected to a wired network.

9. The apparatus of claim 1, wherein the first information acquired by the acquisition module comprises information as to whether the apparatus is supplied power from an external power supply.

10. The apparatus of claim 1, wherein the first information acquired by the acquisition module comprises information as to whether a first program runs on the apparatus.

11. The apparatus of claim 1, further comprising an illuminance sensor, wherein the first information acquired by the acquisition module comprises a value detected by the illuminance sensor.

12. A user assistance method of an information processing apparatus comprising a display and a connector to which an external display is connected, the method comprising:
acquiring first information associated with the apparatus and second information associated with the external display connected to the connector;
recommending a display mode using at least one of the display and the external display connected to the connector, based on the acquired first information and second information and a rule managed for deriving a display mode using at least one of the display and the external display connected to the connector;
setting the apparatus in the recommended display mode, when an image is displayed in the recommended display mode; and
setting the apparatus in a display mode other than the presented display mode and correcting the managed rule, when an image is displayed in a display mode other than the recommended display mode.

13. A computer-readable, non-transitory storage medium having stored thereon a computer program which is executable by a computer, the computer program controlling the computer to function as:
an acquisition module configured to acquire first information associated with the computer and second information associated with an external display connected to a connector of the computer;
a manager configured to manage a rule for deriving a display mode using at least one of a display of the computer and the external display connected to the connector;
a recommendation module configured to recommend a display mode using at least one of the display and the external display connected to the connector, based on the first information and the second information acquired by the acquisition module and the rule managed by the manager; and
a controller configured:
to set the computer in the display mode recommended by the recommendation module, when an image is displayed in the display mode recommended by the recommendation module; and
to set the computer in a display mode other than the display mode recommended by the recommendation module and to correct the rule managed by the manager, when an image is displayed in a display mode other than the display mode recommended by the recommendation module.
